(19) United States
(12) Patent Application Publication
(10) Pub. No.: US 2019/0248628 A1
(43) Pub. Date: Aug. 15, 2019

(54) MAGNETIC BRAKE ACTUATOR ASSEMBLY FOR ELEVATOR SYSTEM

(71) Applicant: OTIS ELEVATOR COMPANY, FARMINGTON, CT (US)

(72) Inventor: Randall S. Dube, Glastonbury, CT (US)

(21) Appl. No.: 15/896,692

(22) Filed: Feb. 14, 2018

(51) Int. Cl. B66B 5/26; B60T 13/74

(52) U.S. Cl. CPC B66B 5/26; B60T 13/748

(57) ABSTRACT

A brake actuator assembly for an elevator system. The assembly includes a safety brake. Also included is a bracket operatively coupleable to an elevator car. Further included is a first magnet operatively coupled to the bracket and rotatable between a first angular position and a second angular position. Yet further included is a second magnet operatively coupled to the bracket, the first and second magnets providing a repulsive magnetic force when the first magnet is in the second angular position to actuate movement of the safety brake into a guide rail.

### BACKGROUND

The disclosure relates generally to elevator systems and, more particularly, to a magnetic brake actuator assembly for such elevator systems.

Elevator braking systems may include a safety braking system configured to assist in braking a hoisted structure (e.g., elevator car) relative to a guide member, such as a guide rail, in the event the hoisted structure exceeds a predetermined speed or acceleration. Various mechanical linkages or electromagnetic systems are typically utilized to facilitate deploying a safety brake (e.g., wedge) into engagement with the guide rail. Magnets may be relied upon to provide a normal force with friction to create a force that enables self-engagement of the safety brake. In such systems, the safety brake is typically not directly moved into engagement with the guide rail.

### BRIEF SUMMARY

Disclosed is a brake actuator assembly for an elevator system. The assembly includes a safety brake. Also included is a bracket operatively coupleable to an elevator car. Further included is a first magnet operatively coupled to the bracket and rotatable between a first angular position and a second angular position. Yet further included is a second magnet operatively coupled to the bracket, the first and second magnets providing a repulsive magnetic force when the first magnet is in the second angular position to actuate movement of the safety brake into a guide rail.

In addition to one or more of the features described above, or as an alternative, further embodiments may include an actuator operatively coupled to the bracket and in operative communication with an over-speed detection device, the actuator moving the first magnet from the first angular position to the second angular position upon detection of an over-speed condition of the elevator car.

In addition to one or more of the features described above, or as an alternative, further embodiments may include that the actuator is a rotary solenoid.

In addition to one or more of the features described above, or as an alternative, further embodiments may include that the rotary solenoid has at least one pin extending therefrom and into a slot defined by the bracket, the magnet operatively coupled to the pin for rotation thereabout.

In addition to one or more of the features described above, or as an alternative, further embodiments may include that the bracket is translatable relative to the rotary solenoid between a first linear position and a second linear position, the change in position actuated by the repulsive magnetic force of the first magnet and the second magnet.

In addition to one or more of the features described above, or as an alternative, further embodiments may include that the rotary solenoid is operatively coupled to the elevator car.

In addition to one or more of the features described above, or as an alternative, further embodiments may include that the actuator is a servomotor.

In addition to one or more of the features described above, or as an alternative, further embodiments may include that the actuator is a torsion spring.

In addition to one or more of the features described above, or as an alternative, further embodiments may include that the bracket is operatively coupled to the safety brake.

In addition to one or more of the features described above, or as an alternative, further embodiments may include that the second magnet is disposed in abutment with the safety brake.

In addition to one or more of the features described above, or as an alternative, further embodiments may include that the second magnet is spaced from the safety brake.

Also disclosed is a brake actuator assembly for an elevator system. The assembly includes a safety brake. Also included is a bracket assembly operatively coupleable to an elevator car, the bracket assembly comprising a first bracket portion and a second bracket portion. Further included is an electromagnet operatively coupled to the first bracket portion, the electromagnet switchable between a first magnetic condition and a second magnetic condition. Yet further included is a magnet operatively coupled to the second bracket portion, the second bracket portion operatively coupled to the safety brake, the electromagnet and magnet providing a repulsive magnetic force when the electromagnet is in the second magnetic condition to actuate movement of the safety brake into a guide rail.

In addition to one or more of the features described above, or as an alternative, further embodiments may include that the first bracket portion is fixed to the elevator car in a stationary arrangement, relative to the elevator car.

In addition to one or more of the features described above, or as an alternative, further embodiments may include that the second bracket portion is translatable relative to the first bracket portion.

Further disclosed is a brake actuator assembly for an elevator system. The assembly includes a safety bracket. Also included is a bracket assembly operatively coupleable to an elevator car, the bracket assembly comprising a first bracket portion and a second bracket portion. Further included is a plurality of first magnets operatively coupled to the first bracket portion and circumferentially spaced from each other. Yet further included is an electromagnetic coil operatively coupled to the first bracket portion and switchable between a first magnetic condition and a second magnetic condition, the second magnetic condition rotating the first bracket portion from a first angular position to a second angular position. Also included is a plurality of second magnets operatively coupled to the second bracket portion, the second bracket portion translatable relative to the first bracket portion between a first translation position and a second translation position, the first and second magnets providing a repulsive magnetic force when the first bracket portion is in the second angular position to actuate movement of the safety brake into a guide rail.

In addition to one or more of the features described above, or as an alternative, further embodiments may include that the second bracket portion is translatable relative to the first bracket portion along a shaft of the first bracket portion.

In addition to one or more of the features described above, or as an alternative, further embodiments may include that the second bracket portion is translatable relative to the first bracket portion along a shaft of the second bracket portion.

In addition to one or more of the features described above, or as an alternative, further embodiments may include that the second bracket portion is in abutment with the safety brake in the first translation position.

In addition to one or more of the features described above, or as an alternative, further embodiments may include that the second bracket portion is spaced from the safety brake in the first translation position.

In addition to one or more of the features described above, or as an alternative, further embodiments may include that the safety brake is a first safety brake, the brake actuator assembly further comprising a second safety brake operatively coupled to the first safety brake, the first and second safety brakes disposed on opposing sides of the guide rail, the repulsive magnetic force actuating movement of the first and safety brake into the guide rail.

### BRIEF DESCRIPTION OF THE DRAWINGS

The present disclosure is illustrated by way of example and not limited in the accompanying figures in which like reference numerals indicate similar elements.

FIG. 1 is a schematic illustration of a brake actuator assembly for an elevator system according to one aspect of the disclosure;

FIG. 2 illustrates the brake actuator assembly of FIG. 1 in a first position;

FIG. 3 illustrates the brake actuator assembly of FIG. 1 in a second position;

FIG. 4 illustrates the brake actuator assembly of FIG. 1 in a third position;

FIG. 5 is a front, elevational schematic illustration of the brake actuator assembly for the elevator system according to another aspect of the disclosure, the brake actuator assembly in a first position;

FIG. 6 is a side, elevational schematic illustration of the brake actuator assembly of FIG. 5 in the first position;

FIG. 7 is a front, elevational schematic illustration of the brake actuator assembly of FIG. 5 in a second position; and

FIG. 8 is a schematic illustration of the brake actuator assembly for the elevator system according to another aspect of the disclosure, the brake actuator assembly in a first position;

FIG. 9 illustrates the brake actuator assembly of FIG. 8 in a second position; and

FIG. 10 illustrates the brake actuator assembly of FIG. 8 being reset from the second position to the first position.

### DETAILED DESCRIPTION

The Figures illustrate a portion of a brake assembly for an elevator system according to various embodiments of the disclosure. The embodiments described herein relate to an overall braking assembly that is operable to assist in braking (e.g., slowing or stopping movement) of an elevator car relative to a guide rail that is fixed within an elevator car passage and is configured to guide the elevator car, typically in a vertical manner. The brake assembly can be used with various types of elevator systems. For example, the embodiments described herein may be used with roped, ropeless, or hydraulic elevator systems. Furthermore, it is to be appreciated that any of the embodiments described herein may be employed with symmetric or asymmetric brake assemblies. In symmetric assemblies, it is contemplated that single or dual brake actuator assemblies may be employed on each side of the guide rail to split the required actuator force. In the embodiments described herein, the safety brake (e.g., wedge) may be pushed up or downward to enable engagement with a guide rail.

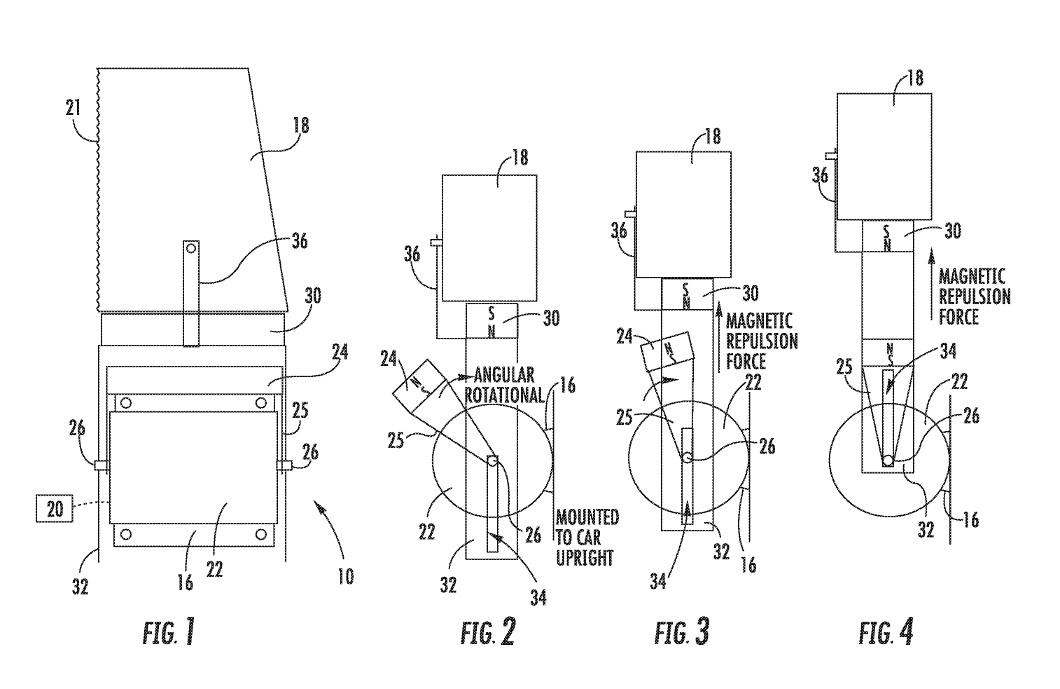

Referring now to FIG. 1, a brake actuator assembly according to an embodiment of the disclosure is illustrated and generally referenced with numeral 10. The brake actuator assembly 10 includes a mounting structure 16, such as an elevator car frame, and a safety brake 18. The safety brake 18 includes a brake pad 21 (FIG. 1) or a similar structure suitable for repeatable braking engagement with the guide rail. The mounting structure 16 is connected to the elevator car and the safety brake 18 is positioned on the mounting structure 16 in a manner that disposes the brake member 18 in proximity with the guide rail. The safety brake 18 includes at least one component, such as the brake pad 21, having a contact surface that is operable to frictionally engage the guide rail. In some embodiments, the brake pad 21 is a separate part secured to the safety brake 18. In other embodiments, the brake pad 21 is not a separate part, such as a special and purposeful treatment of one or more surfaces of the safety brake 18, for example.

The safety brake 18 is operable between a non-braking position and a braking position. The non-braking position is a position that the safety brake 18 is disposed in during normal operation of the elevator car. In particular, the safety brake 18 is not in contact with the guide rail while in the non-braking position, and thus does not frictionally engage the guide rail. In the braking position, the frictional force between the contact surface of the safety brake 18 and the guide rail is sufficient to stop movement of the elevator car relative to the guide rail, or decelerate its movement to levels considered safe or acceptable for other elevator system components to stop the elevator car.

In operation, an electronic sensing device and/or control system 20 is configured to monitor various parameters and conditions of the elevator car and to compare the monitored parameters and conditions to at least one predetermined condition. The electronic sensing device and/or control system 20 may be independent of the magnetic brake actuator assembly 10, but may be integrated therewith. In one embodiment, the predetermined condition comprises speed and/or acceleration of the elevator car. In the event that the monitored condition (e.g., over-speed, over-acceleration, etc.) meets or exceeds the predetermined condition, the brake actuator assembly 10 is actuated to facilitate engagement of the safety brake 18 and the guide rail. It is to be appreciated that the safety brake 18 may be pushed up in some embodiments to engage the guide rail and downward in other embodiments to engage the guide rail.

The brake actuator assembly 10 includes an actuator 22 that is operatively coupled to the mounting structure 16. The actuator 22 may be directly or indirectly coupled to the elevator car, such as with the mounting structure 16, which may be a bracket or the like, as shown in FIG. 2. The actuator 22 is any device suitable for imparting rotation of a first magnet (or first group of magnets) 24, as will be appreciated from the description herein. For example, the actuator 22 may be a rotary solenoid, a motor such as a servomotor, a torsion spring, or any other suitable rotational structure. In the illustrated embodiment, a rotary solenoid is shown as the actuator 22, but it is to be appreciated that any of the aforementioned rotational structures may be suitable for the embodiments of FIGS. 1-4.

The first magnet 24 is operatively coupled to the actuator 22. In the illustrated embodiment, the first magnet 24 includes a structure 25 that is coupled to a pin, axle, shaft, etc. 26 extending from the actuator 22. The actuator 22 may include pins extending from both sides thereof, as illustrated. The first magnet 24 is rotatable about the pin 26 from a first angular position (FIG. 2) to a second angular position (FIGS. 3 and 4). The first magnet 24 is in the first angular position during normal operation of the elevator car. The actuator 22 is in operative communication (wired or wireless) with the electronic sensing device and/or control system 20. Upon detection of meeting or exceeding one of the predetermined conditions (e.g., over-speed, over-acceleration, etc.), the electronic sensing device and/or control system 20 sends a signal and/or pulse to the actuator 22, which then causes the actuator 22 to rotate the first magnet 24 to the second angular position of FIGS. 3 and 4. In the case of a rotary solenoid, the solenoid is energized to impart high-speed rotation of the first magnet 24.

Referring now to FIG. 3, rotation of the first magnet 24 to the second angular position substantially aligns the first magnet 24 with a second magnet (or group of second magnets) 30 that is mounted to a bracket 32. In the illustrated embodiment, the second magnet 30 is mounted to the top of the bracket 32. The first and second magnets 24, 30 are oriented such that a common polarity (N-N or S-S) of the magnets are closest to each other in the second angular position of the first magnet 24. In the substantially aligned position of the magnets 24, 30, the alignment of the polarity of the magnets provides a repulsive magnetic force. Although the repulsive magnetic force is discussed in the substantially aligned position, it is to be appreciated that the repulsive force begins before the magnets 24, 30 are aligned and increases to a maximum force when aligned. Although shown as aligned in parallel in the second angular position of the first magnet 24, it is to be appreciated that other relative orientations may be used to modify the repulsive magnetic force generated by movement of the first magnet 24 to the second angular position. Additionally, the speed of rotation of the first magnet 24 may be customized to modify the magnetic force generated. The speed of rotation and the air gap between the magnets 24, 30 controls the force, as well as the speed/acceleration of movement of the magnet 30.

Referring now to FIG. 4, the repulsive magnetic force applied biases the safety brake 18 away from the first magnet 24 to initiate engagement of the safety brake 18 with the guide rail. This is facilitated by translation of the bracket 32 relative to the first magnet 24. In particular, the bracket 32 includes a slot 34 defined therein for receiving the pin 26. Mounting of the second magnet 30 to the bracket 32 biases the bracket 32 upwardly with the second magnet 30 due to the magnetic force. The slot 34 allows translation between a first position (FIGS. 2 and 3) and a second position (FIG. 4). Biasing the safety brake 18 may be performed by moving the second magnet 30 into abutment with the safety brake 18 or the second magnet 30 may always remain in abutment with the safety brake 18. Alternatively, or in combination with abutment of the second magnet 30 with the safety brake 18, an arm 36 may extend from the bracket 32 into fixed engagement with the safety brake 18, thereby facilitating a fixed gap between the safety brake 18 and the magnet 30. The arm 36 ensures movement of the safety brake 18 with the bracket 32 which is beneficial during resetting of the safety brake 18. The safety brake 18 is reset with movement of the elevator car upward which provides downward movement of the safety brake 18 and energizing the control system 20 to return the constituents of the magnetic brake actuator assembly 10 to normal operation.

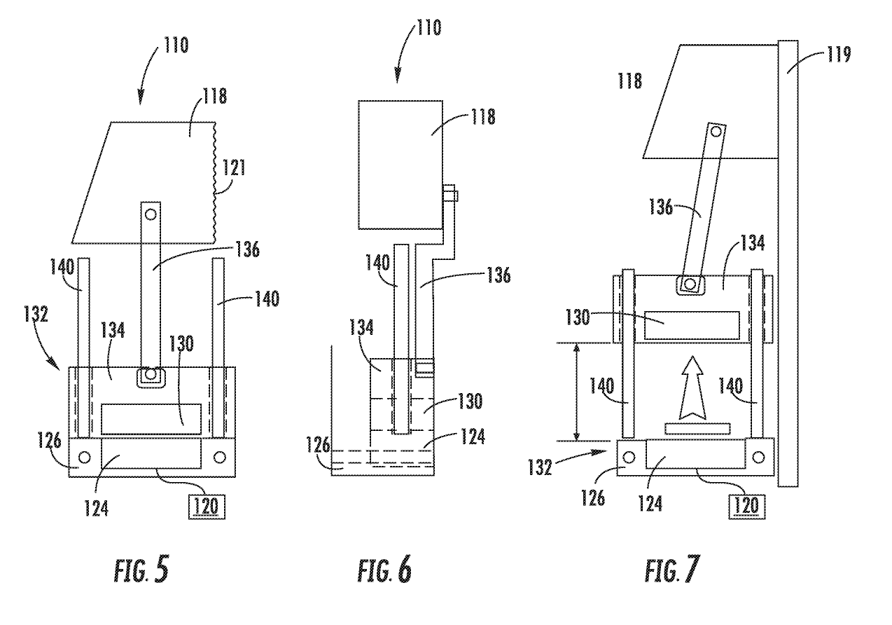

Referring now to FIGS. 5 and 6, a brake actuator assembly according to an embodiment of the disclosure is illustrated and generally referenced with numeral 110. The brake actuator assembly 110 includes a safety brake 118. The safety brake 118 includes a brake pad 121 (FIG. 5) or a similar structure suitable for repeatable braking engagement with guide rail 119 (FIG. 7). The safety brake 118 is positioned in a manner that disposes the brake member 118 in proximity with the guide rail 119. The safety brake 118 includes at least one component, such as the brake pad 121, having a contact surface that is operable to frictionally engage the guide rail 119. In some embodiments, the brake pad 121 is a separate part secured to the safety brake 118. In other embodiments, the brake pad 121 is not a separate part, such as a special and purposeful treatment of one or more surfaces of the safety brake 118, for example.

The safety brake 118 is operable between a non-braking position (FIGS. 5 and 6) and a braking position (FIG. 7). The non-braking position is a position that the safety brake 118 is disposed in during normal operation of the elevator car. In particular, the safety brake 118 is not in contact with the guide rail 119 while in the non-braking position, and thus does not frictionally engage the guide rail 119. In the braking position, the frictional force between the contact surface of the safety brake 118 and the guide rail 119 is sufficient to stop movement of the elevator car relative to the guide rail 119, or decelerate its movement to levels considered safe or acceptable for other elevator system components to stop the elevator car.

In operation, an electronic sensing device and/or control system 120 is configured to monitor various parameters and conditions of the elevator car and to compare the monitored parameters and conditions to at least one predetermined condition. The electronic sensing device and/or control system 120 may be independent of the magnetic brake actuator assembly 110, but may be integrated therewith. In one embodiment, the predetermined condition comprises speed and/or acceleration of the elevator car. In the event that the monitored condition (e.g., over-speed, over-acceleration, etc.) meets or exceeds the predetermined condition, the brake actuator assembly 110 is actuated to facilitate engagement of the safety brake 118 and the guide rail 119. It is to be appreciated that the safety brake 118 may be pushed up in some embodiments to engage the guide rail and downward in other embodiments to engage the guide rail.

The brake actuator assembly 110 includes an electromagnet 124 that is operatively coupled to a first bracket portion 126 of a bracket assembly 132. The first bracket portion 126 is stationary, relative to the elevator car to which it is operatively coupled to. In the normal operating condition of the elevator car, as shown in FIGS. 5 and 6, the polarity of the electromagnet 124 is such that an attractive magnetic force is applied between the electromagnet 124 and a magnet 130 that is mounted to a second bracket portion 134 of the bracket assembly 132.

Referring now to FIG. 7, the electromagnet 124 is in operative communication (wired or wireless) with the electronic sensing device and/or control system 120. Upon detection of meeting or exceeding one of the predetermined conditions (e.g., over-speed, over-acceleration, etc.), the electronic sensing device and/or control system 120 sends a signal and/or pulse to the electromagnet 124, which causes a reversal of polarity of the electromagnet 124. As shown in FIG. 7, reversing the polarity of the electromagnet 124 provides a repulsive magnetic force between the electromagnet 124 and the magnet 130. The repulsive magnetic force applied biases the safety brake 118 away from the first electromagnet 124 to initiate engagement of the safety brake 118 with the guide rail 119. This is facilitated by translation of the second bracket portion 134 relative to the first bracket portion 126. In the illustrated embodiment, the first bracket portion 126 includes a pair of rails 140 that the second bracket portion 134 is translatable along.

Mounting of the magnet 130 to the second bracket portion 134 biases the second bracket portion 134 upwardly with the magnet 130 due to the repulsive magnetic force. Such movement of the second bracket portion 134 and the magnet 130 from a first translation position (FIGS. 5 and 6) to a second translation position (FIG. 7) biases the safety brake 118 into engagement with the guide rail 119. Movement of the safety brake 118 is carried out with movement of the second bracket portion 134 due to an arm 136 that extends from the second bracket portion 134 into engagement with the safety brake 118. In some embodiments, engagement is made with a pin type joint that allows the safety brake 118 to move upward and translate laterally, engaging the safety brake 118 with the guide rail, as necessary. The arm 136 ensures movement of the safety brake 118 with the second bracket portion 134 which is also beneficial during resetting of the safety brake 118. The safety brake 118 is reset with movement of the elevator car upward which provides downward movement of the safety brake 118 and energizing the control system 120 to return the constituents of the magnetic brake actuator assembly 110 to normal operation.

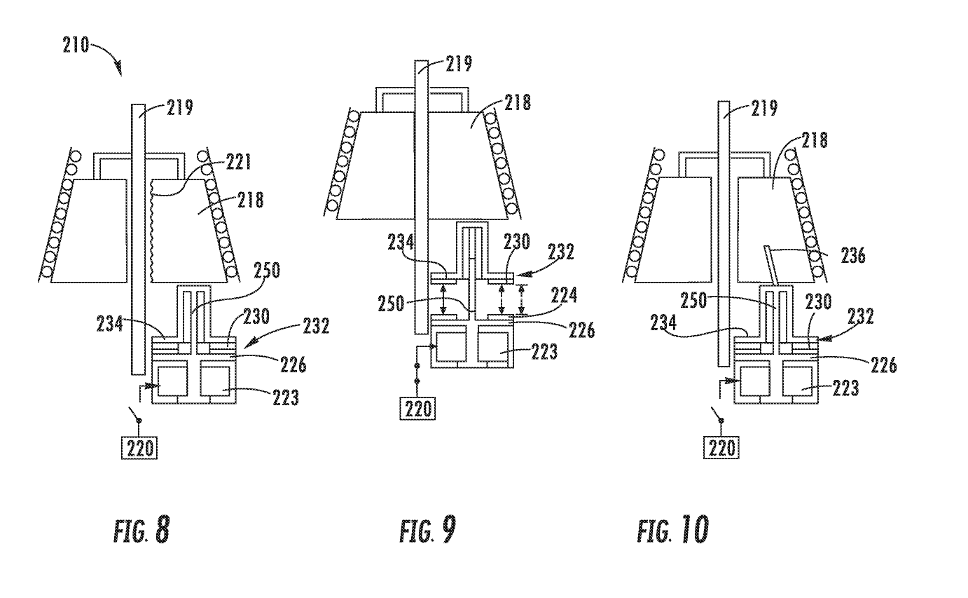

Referring now to FIG. 8, a brake actuator assembly according to an embodiment of the disclosure is illustrated and generally referenced with numeral 210. The brake actuator assembly 210 includes a safety brake 218. The safety brake 218 includes a brake pad 221 or a similar structure suitable for repeatable braking engagement with a guide rail 219. The safety brake 218 is positioned in a manner that disposes the brake member 218 in proximity with the guide rail 219. The safety brake 218 includes at least one component, such as the brake pad 221, having a contact surface that is operable to frictionally engage the guide rail 219. In some embodiments, the brake pad 221 is a separate part secured to the safety brake 218. In other embodiments, the brake pad 221 is not a separate part, such as a special and purposeful treatment of one or more surfaces of the safety brake 218, for example.

The safety brake 218 is operable between a non-braking position (FIG. 8) and a braking position (FIG. 9). The non-braking position is a position that the safety brake 218 is disposed in during normal operation of the elevator car. In particular, the safety brake 218 is not in contact with the guide rail 219 while in the non-braking position, and thus does not frictionally engage the guide rail 219. In the braking position, the frictional force between the contact surface of the safety brake 218 and the guide rail 219 is sufficient to stop movement of the elevator car relative to the guide rail 219, or decelerate its movement to levels considered safe or acceptable for other elevator system components to stop the elevator car.

In operation, an electronic sensing device and/or control system 220 is configured to monitor various parameters and conditions of the elevator car and to compare the monitored parameters and conditions to at least one predetermined condition. In one embodiment, the predetermined condition comprises speed and/or acceleration of the elevator car. In the event that the monitored condition (e.g., over-speed, over-acceleration, etc.) meets or exceeds the predetermined condition, the brake actuator assembly 210 is actuated to facilitate engagement of the safety brake 218 and the guide rail 219. It is to be appreciated that the safety brake 218 may be pushed up in some embodiments to engage the guide rail and downward in other embodiments to engage the guide rail.

The brake actuator assembly 210 includes a rotary solenoid 223, such as an electromagnetic coil, that is switchable between a first magnetic condition and a second magnetic condition. The first magnetic condition corresponds to a first angular position and the second magnetic condition corresponds to a second angular position. The electromagnetic coil 223 is operatively coupled to a first bracket portion 226 of a bracket assembly 232. The first bracket portion 226 rotates, but is stationary relative to the elevator car to which it is operatively coupled to.

A plurality of first magnets 224 (FIG. 9) is disposed on—or within—the first bracket portion 226. The first magnets 224 are circumferentially spaced from each other and are moveable with the first bracket portion 226 in response to rotation of the rotary solenoid 223. In the normal operating condition of the elevator car, as shown in FIG. 8, the first magnets 224 are positioned to be offset (regarding opposing magnetic poles) from a plurality of second magnets 230 mounted to a second bracket portion 234 of the bracket assembly 232 to prevent a magnetic repulsive force from forming between second bracket portion 234 and first bracket portion 226.

Referring now to FIG. 9, the rotary solenoid 223 is in operative communication (wired or wireless) with the electronic sensing device and/or control system 220. Upon detection of meeting or exceeding one of the predetermined conditions (e.g., over-speed, over-acceleration, etc.), the electronic sensing device and/or control system 220 sends a signal and/or pulse to the rotary solenoid 223, which then causes the rotary solenoid 223 to rotate the first bracket portion 226 and the first magnets 224 away from the first angular position to the second angular position of FIG. 9. Rotation of the first magnets 224 to the second angular position substantially aligns the first magnets 224 with the second magnets 230.

The first and second magnets 224, 230 are oriented such that a common polarity (N-N or S-S) of the magnets are closest to each other in the second angular position of the first magnets 224. In the substantially aligned position of the magnets 224, 230, the alignment of the polarity of the magnets provides a repulsive magnetic force. Although the repulsive magnetic force is discussed in the substantially aligned position, it is to be appreciated that the repulsive force begins before the magnets 224, 230 are aligned and increases to a maximum force when aligned. The repulsive magnetic force applied biases the second bracket portion 234 away from the first magnets 224 and the first bracket portion 226 to initiate engagement of the safety brake 218 with the guide rail 219. This is facilitated by translation of the second bracket portion 234 relative to the first bracket portion 226. In the illustrated embodiment, the first bracket portion 226 includes a shaft 250 extending upwardly therefrom, but it is to be appreciated that a shaft may not be present and an alternative guiding structure may be employed in some embodiments. The second bracket portion 234 includes a cylindrical portion with a hollow center disposed on the shaft 250 and is translatable along. It is to be appreciated that the second bracket portion 234 may include a downwardly extending shaft, with the first bracket portion 226 having a cylindrical portion with a hollow center disposed on the shaft of the second bracket portion 234.

Mounting of the second magnets 230 to the second bracket portion 234 biases the second bracket portion 234 upwardly with the second magnets 230 due to the repulsive magnetic force. Such movement of the second bracket portion 234 and the second magnets 230 from a first translation position (FIG. 8) to a second translation position (FIG. 9) biases the safety brake 218 into engagement with the guide rail 219. Biasing the safety brake 218 may be performed by moving the second bracket portion 234 into abutment with the safety brake 218 or the second bracket portion 234 may always remain in abutment with the safety brake 218. Alternatively, or in combination with abutment of the second bracket portion 234 with the safety brake 218, an arm 236 (FIG. 10) may extend from the second bracket portion 234 into fixed engagement with the safety brake 218. The arm 236 ensures movement of the safety brake 218 with the second bracket portion 234 which is also beneficial during resetting of the safety brake 218, as shown in FIG. 10. The safety brake 218 is reset with movement of the elevator car upward which provides downward movement of the safety brake 218 and energizing the control system 220 to return the constituents of the magnetic brake actuator assembly 210 to normal operation.

In each of the illustrated embodiments, and those described above, the repulsive magnetic force is applied to bias a magnet upwardly to engage the safety with the guide rail. However, it is to be understood that in some embodiments the techniques described in the disclosed embodiments are applied to move the safety horizontally or at any angle theoretically as long as the end position is in contact with the guide rail, with the intended purpose to decelerate the car, as some systems have wedges/rollers that are applied at angles other than vertical.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., a processor, apparatus or system) to perform one or more methodological acts as described herein.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments have been described, it is to be understood that aspects of the disclosure may include only some of the described embodiments. Accordingly, the disclosure is not to be seen as limited by the foregoing description, but is only limited by the scope of the appended claims

What is claimed is:

1. A brake actuator assembly for an elevator system comprising:
a safety brake;
a bracket operatively coupleable to an elevator car;
a first magnet operatively coupled to the bracket and rotatable between a first angular position and a second angular position; and
a second magnet operatively coupled to the bracket, the first and second magnets providing a repulsive magnetic force when the first magnet is in the second angular position to actuate movement of the safety brake into a guide rail.

2. The brake actuator assembly of claim 1, further comprising an actuator operatively coupled to the bracket and in operative communication with an over-speed detection device, the actuator moving the first magnet from the first angular position to the second angular position upon detection of an over-speed condition of the elevator car.

3. The brake actuator assembly of claim 2, wherein the actuator is a rotary solenoid.

4. The brake actuator assembly of claim 3, the rotary solenoid having at least one pin extending therefrom and into a slot defined by the bracket, the magnet operatively coupled to the pin for rotation thereabout.

5. The brake actuator assembly of claim 4, wherein the bracket is translatable relative to the rotary solenoid between a first linear position and a second linear position, the change in position actuated by the repulsive magnetic force of the first magnet and the second magnet.

6. The brake actuator assembly of claim 3, wherein the rotary solenoid is operatively coupled to the elevator car.

7. The brake actuator assembly of claim 2, wherein the actuator is a servomotor.

8. The brake actuator assembly of claim 2, wherein the actuator is a torsion spring.

9. The brake actuator assembly of claim 1, wherein the bracket is operatively coupled to the safety brake.

10. The brake actuator assembly of claim 1, wherein the second magnet is disposed in abutment with the safety brake.

11. The brake actuator assembly of claim 1, wherein the second magnet is spaced from the safety brake.

12. A brake actuator assembly for an elevator system comprising:
a safety brake;
a bracket assembly operatively coupleable to an elevator car, the bracket assembly comprising a first bracket portion and a second bracket portion;
an electromagnet operatively coupled to the first bracket portion, the electromagnet switchable between a first magnetic condition and a second magnetic condition; and
a magnet operatively coupled to the second bracket portion, the second bracket portion operatively coupled to the safety brake, the electromagnet and magnet providing a repulsive magnetic force when the electromagnet is in the second magnetic condition to actuate movement of the safety brake into a guide rail.

13. The brake actuator assembly of claim 12, wherein the first bracket portion is fixed to the elevator car in a stationary arrangement, relative to the elevator car.

14. The brake actuator assembly of claim 13, wherein the second bracket portion is translatable relative to the first bracket portion.

15. A brake actuator assembly for an elevator system comprising:
a safety brake;
a bracket assembly operatively coupleable to an elevator car, the bracket assembly comprising a first bracket portion and a second bracket portion;
a plurality of first magnets operatively coupled to the first bracket portion and circumferentially spaced from each other;
an electromagnetic coil operatively coupled to the first bracket portion and switchable between a first magnetic condition and a second magnetic condition, the second magnetic condition rotating the first bracket portion from a first angular position to a second angular position; and
a plurality of second magnets operatively coupled to the second bracket portion, the second bracket portion translatable relative to the first bracket portion between a first translation position and a second translation position, the first and second magnets providing a repulsive magnetic force when the first bracket portion is in the second angular position to actuate movement of the safety brake into a guide rail.

16. The brake actuator assembly of claim 15, wherein the second bracket portion is translatable relative to the first bracket portion along a shaft of the first bracket portion.

17. The brake actuator assembly of claim 15, wherein the second bracket portion is translatable relative to the first bracket portion along a shaft of the second bracket portion.

18. The brake actuator assembly of claim 15, wherein the second bracket portion is in abutment with the safety brake in the first translation position.

19. The brake actuator assembly of claim 15, wherein the second bracket portion is spaced from the safety brake in the first translation position.

20. The brake actuator assembly of claim 15, wherein the safety brake is a first safety brake, the brake actuator assembly further comprising a second safety brake operatively coupled to the first safety brake, the first and second safety brakes disposed on opposing sides of the guide rail, the repulsive magnetic force actuating movement of the first and safety brake into the guide rail.
